(19) United States
(12) Patent Application Publication
(10) Pub. No.: US 2007/0141995 A1
(43) Pub. Date: Jun. 21, 2007

(54) Method for controlling interference in a wireless mobile communication system

(75) Inventors: II- Jin Youn, Bucheun-si (KR); Byung- Chan Ahn, Seoul (KR); Young-Soon Lee, Yongin-si (KR)

Correspondence Address: THE FARRELL LAW FIRM, P.C., 333 EARLE OVINGTON BOULEVARD, SUITE 701, UNIONDALE, NY, 11553, US

(73) Assignee: SAMSUNG ELECTRONICS CO., LTD., Gyeonggi-do (KR)

(21) Appl. No.: 11/639,756

(22) Filed: Dec. 15, 2006

(30) Foreign Application Priority Data
Dec. 15, 2005 (KR) 124109-2005

(51) Int. Cl. H04B 7/00; H04B 1/00

(52) U.S. Cl. 455/69; 455/63.1; 455/522; 455/525

(57) ABSTRACT

Disclosed is a method for controlling interference signals by a base station in a wireless mobile communication system, the method including classifying a plurality of mobile stations into first and second mobile station groups including the mobile stations having good channel conditions and the mobile stations having poor channel conditions, respectively; and setting first and second thresholds for controlling interferences of the mobile stations belonging to the first mobile station group, adjusting downward an Modulation and Coding Scheme (MCS) level for the mobile stations having Rise over Thermal (RoT) values higher than the first thresholds, and adjusting downward the maximum allowable MCS level for the mobile stations having RoT values lower than the second threshold.

### PRIORITY

This application claims the benefit under 35 U.S.C. §119 to an application filed in the Korean Industrial Property Office on Dec. 15, 2005 and assigned Serial No. 2005-124109, the contents of which are incorporated herein by reference.

### BACKGROUND OF THE INVENTION

1. Field of the Invention

The present invention relates generally to a wireless mobile communication system, and in particular to a method for controlling uplink interference signals by a base station in a wireless mobile communication system.

2. Description of the Related Art

For uplink scheduling, a conventional wireless mobile communication system, such as a Code Division Multiple Access (CDMA) communication system, uses a method of collectively adjusting upward or downward the data transfer rates of all mobile stations within a cell. That is, the CDMA communication system has been able to apply a data transfer rate control method which enables the transmission powers of all mobile stations to reach a base station at a certain reception power irrespective of distance between the base station and the mobile stations by directly controlling Rise over Thermal (RoT ), which refers to a ratio of the sum of other-cell interference and thermal noise to the thermal noise.

Specifically, each base station of the CDMA communication system measures the sum of own-cell signal interference, other-cell signal interference and thermal interference. If the sum of interferences exceeds a predetermined threshold, each base station lowers the weight of the own-cell signal interference by collectively decreasing the data transfer rates of mobile stations located in the corresponding base station. Alternatively, if the sum of interference is equal to or less than the predetermined threshold, each base station raises the weight of the own-cell signal interference by collectively increasing the data transfer rates of mobile stations located in the corresponding base station. Such a method is effective in that, since the own-cell signal occupies a very large portion of the sum of interference, which each base station suffers from in the CDMA communication system, each base station can control the overall interference of the communication system only by controlling the own-cell signal interference, which makes it possible to ensure the data transfer rate of each mobile station at a certain level.

However, the above-mentioned method for ensuring the data transfer rate of a mobile station cannot be applied to a broadband wireless access communication system based on the Institute of Electrical and Electronics Engineers (IEEE) 802.16e standard or a 2.3 GHz portable Internet (Wibro) communication system, which has been researched and put to practical use as a next generation mobile communication system. This is because there is little own-cell signal interference in such communication systems. Features distinguishing these communication systems from the conventional CDMA communication system are set forth below.

Hereinafter, for the convenience of explanation, the broadband wireless access communication system and the 2.3 GHz portable Internet communication system will be generically referred to as “Wibro communication system”.

Foremost, in the Wibro communication system, a base station performs synchronization through a ranging process between mobile stations such that signals transmitted from different mobile stations simultaneously reach the base station, and gets the mobile stations to insert a cyclic prefix interval into a transmitted data burst to thereby prevent mutual interference between signals reaching the base station via multi-paths at different times. Further, since the Wibro communication system employs an Orthogonal Frequency Division Multiple Access (OFDMA) scheme, it has orthogonality between subcarriers. Thus, a signal from a mobile station to which a specific slot is allocated does not act as interference to a signal from a mobile station to which another slot is allocated.

Further, a data transfer frame used in the Wibro communication system is configured in two-dimensions of frequency and time. On this account, the data transfer rate of each mobile station has nothing to do with interference, and thus it is impossible to use the existing method in which interference is controlled by collectively adjusting data transfer rates.

### SUMMARY OF THE INVENTION

Accordingly, the present invention has been made to solve at least the above-mentioned problems occurring in the conventional art, and an object of the present invention is to provide a method for efficiently controlling uplink interference signals in a wireless mobile communication system.

In order to achieve an aspect of the present invention, there is provided a method for controlling interference signals by a base station in a wireless mobile communication system, the method includes classifying a plurality of mobile stations into a first mobile station group including the mobile stations having good channel conditions with respect to the base station and a second mobile station group including the mobile stations having poor channel conditions with respect to the base station; setting a first threshold and a second threshold for controlling interferences of the mobile stations belonging to the first mobile station group, adjusting downward a maximum allowable Modulation and Coding Scheme (MCS) level for the mobile stations having RoT values higher than the first thresholds, and adjusting downward the maximum allowable MCS level for the mobile stations having RoT values lower than the second threshold; and setting a third threshold, a fourth threshold and a fifth threshold for controlling interferences of the mobile stations belonging to the second mobile station group, adjusting downward the fifth threshold to increase a ratio of the mobile stations capable of using the maximum allowable MCS level if there are mobile stations having RoT values higher than the third threshold, and adjusting upward the fifth threshold to decrease the ratio of the mobile stations capable of using the maximum allowable MCS level, if there are mobile stations having RoT values lower than the fourth threshold.

In accordance with another aspect of the present invention, there is provided a method for controlling interference signals by a base station in a wireless mobile communication system, the method includes classifying a plurality of mobile stations into a first mobile station group including the mobile stations having good channel conditions with respect to the base station and a second mobile station group including the mobile stations having poor channel conditions with respect to the base station; and adjusting upward a second threshold, which is set for applying MCS levels of the mobile stations belonging to the second mobile station group, by a predetermined value if an average RoT value exceeds a predetermined first threshold, and adjusting downward the second threshold by a predetermined value if the average RoT value is equal to or less than the first threshold.

### BRIEF DESCRIPTION OF THE DRAWINGS

The above and other objects, features and advantages of the present invention will be more apparent from the following detailed description taken in conjunction with the accompanying drawings, in which:

FIG. 1 is a diagrammatic view illustrating a way of controlling interference from an Edge mobile station in a wireless mobile communication system in accordance with a first preferred embodiment of the present invention;

FIG. 2 is a diagrammatic view illustrating a way of controlling interference from a Near mobile station in a wireless mobile communication system in accordance with a second preferred embodiment of the present invention;

FIG. 3 is a flowchart illustrating a procedure in which a base station performs interference control in accordance with the first and second preferred embodiments of the present invention;

FIGS. 4A and 4B are graphs of simulation results, that compare effectiveness of the present invention with that of the conventional art;

FIG. 5 is a diagrammatic view illustrating a way of interference control in accordance with a third preferred embodiment of the present invention; and

FIG. 6 is a diagrammatic view illustrating another way of interference control in accordance with the third preferred embodiment of the present invention.

### DETAILED DESCRIPTION OF THE PREFERRED EMBODIMENT

Hereinafter, preferred embodiments of the present invention will be described with reference to the accompanying drawings. It should be noted that the similar components are designated by similar reference numerals although they are illustrated in different drawings. Also, in the following description, a detailed description of known functions and configurations incorporated herein will be omitted when it may obscure the subject matter of the present invention.

The present invention classifies mobile stations into two categories, that is, a mobile station located near a base station (Near mobile station) and a mobile station located at a cell edge (Edge mobile station), and provides a method for controlling uplink signal interference in a wireless mobile communication system with respect to each of the Near and Edge mobile stations.

The present invention can be preferably applied to a broadband wireless access communication system employing orthogonal frequencies and a portable Internet (that is, Wibro) system. Hereinafter, the term “Wibro communication system” will be used as a generic term for the broadband wireless access communication system and the portable Internet system. Further, the present invention can be applied to all the controls of inter-cell interference signals, inter-sector interference signals and interference signals between a cell and a sector. Hereinafter, for the convenience of explanation only the control of inter-cell interference signals will be described.

First, a way of controlling interference from the Edge mobile station will be described in a first embodiment of the present invention, and then a way of controlling interference from the Near mobile station will be described in a second embodiment of the present invention.

Prior to the description of the first and second embodiments, a general interference control method will be discussed.

In the general interference control method, if an effective Rise over Thermal (effective RoT) value becomes large, a base station collectively lowers the Modulation and Coding Scheme (MCS) levels of all mobile terminals belonging to a cell and uses the lowered MCS levels. When such a general interference control method is applied to the uplink signal interference control of the Wibro communication system, a first base station adjusts downward the MCS levels of mobile stations existing in its own cell to thereby reduce the amount of interference signals acting on a neighbor cell. Thereupon, a second base station of the neighbor cell controls the transmission powers of mobile stations belonging to its own cell to be lowered, which in turn reduces the amount of interference signals acting on the cell of the first base station.

However, the interference control method as stated above has a disadvantage in that too much time is required for the interference control. Further, if the base station schedules a mobile station using a higher MCS level and then schedules a mobile station using a lower MCS level, the neighbor cell is subjected to large fluctuations in interference signals. Moreover, although the base station can control a Near mobile station to use a high data transfer rate by using a high transmission power, it collectively limits data transfer rates due to an Edge mobile station, resulting in deterioration of the overall system processing performance.

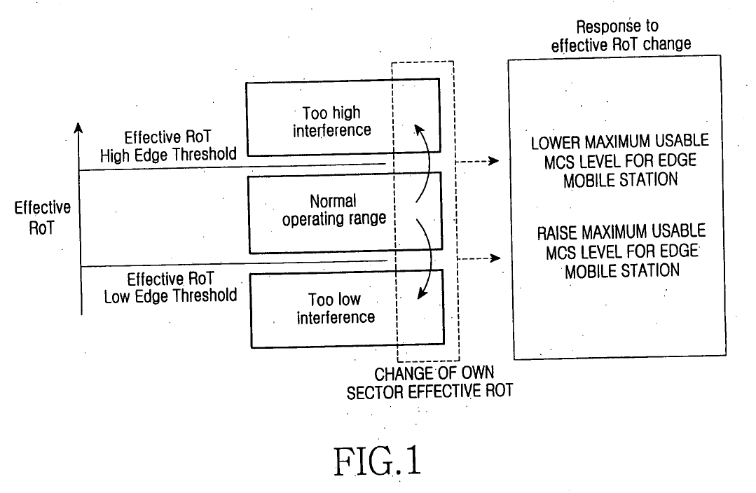

Therefore, in the first embodiment of the present invention, reference will be made to a way of controlling interference from the Edge mobile station, which causes much interference to a neighbor cell, with reference to FIG. 1.

FIG. 1 is a diagrammatic view illustrating a way of controlling interference from an Edge mobile station in a wireless mobile communication system according to the first embodiment of the present invention.

Foremost, it should be understood that a base station uses average Channel Quality Information (CQI) as a yardstick for discriminating a mobile station causing much interference to a neighbor cell from other mobile stations. In general, an Edge mobile station located at a cell edge (or having poor channel conditions) reports relatively lower CQI, and a Near mobile station located in the center of a cell (or having good channel conditions) reports relatively higher CQI. Thus, the base station sets a threshold for the discrimination between the Edge mobile station and the Near mobile station, and classifies a mobile station reporting CQI higher than the threshold as the Near mobile station and classifies a mobile station reporting CQI lower than the threshold as the Edge mobile station.

Referring to FIG. 1, the base station presets an Effective RoT High Edge Threshold and an Effective RoT Low Edge Threshold as a first threshold and a second threshold for controlling interference from the Edge mobile station, respectively. It is obvious that these thresholds can be appropriately set according to the systems to be implemented.

If an effective RoT value exceeds the first threshold, the base station adjusts downward the maximum allowable MCS level of the Edge mobile station. Here, the maximum allowable MCS level refers to a maximum MCS level allocated to the Edge mobile station from among various MCS levels allocable to the Edge mobile station. The downward adjustment of the maximum allowable MCS level by the base station reduces the influence of the effective RoT value on the base station's own cell. On the contrary, if the effective RoT value becomes lower than the second threshold, the base station adjusts upward the maximum allowable MCS level of the Edge mobile station. This leads to a rise of the effective RoT value's influence on the base station's own cell.

That is, if the base station adjusts downward the maximum allowable MCS level, the amount of interference signals acting on a neighbor cell is reduced. Consequently, the base station of the neighbor cell controls a mobile station existing in the neighbor cell to lower its transmission power, and the Edge mobile station belonging to the base station is less affected by interference from the neighbor cell, so that the effective RoT value becomes lower.

Further, if the base station adjusts upward the maximum allowable MCS level, the amount of interference acting on the neighbor cell is enlarged. As a result, the base station of the neighbor cell controls a mobile station existing in the neighbor cell to raise its transmission power, and the Edge mobile station belonging to the base station is more affected by interference from the neighbor cell, so that the effective RoT value becomes higher.

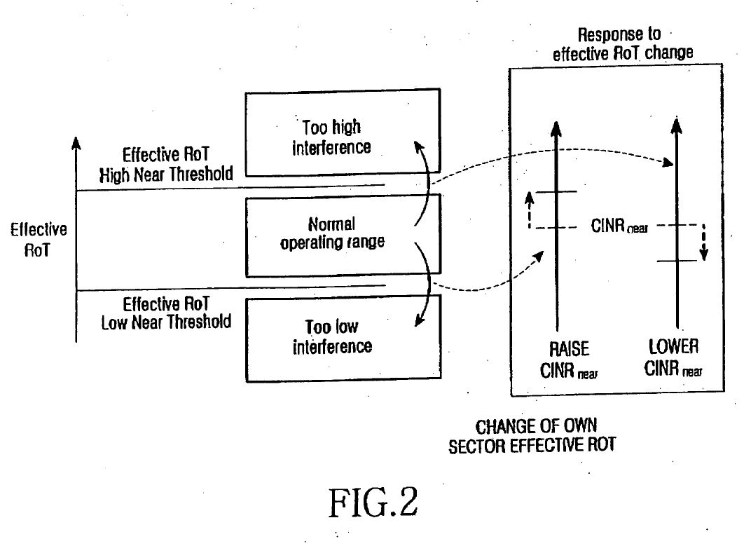

FIG. 2 diagrammatic view illustrates a way of controlling interference from a Near mobile station in a wireless mobile communication system according to the second embodiment of the present invention.

Referring to FIG. 2, a base station must perform an interference control for an Edge mobile station according to the first embodiment and also perform an interference control for a Near mobile station according to the second embodiment. Thus, in the second embodiment, similar to the first embodiment, an Effective RoT High Near Threshold and an Effective RoT Low Near Threshold are preset as a third threshold and a fourth threshold for controlling the interference from the Near mobile station, respectively, and a CINR_{Near} as a fifth threshold is initially set and then is adjusted upward or downward. It is also obvious that the third, fourth and fifth thresholds may be appropriately set according to systems to be implemented. Here, the third and fourth thresholds are set for adjusting upward or downward the fifth threshold, and the fifth threshold is a criterion for allocating an MCS level to a mobile station.

If an effective RoT value of the overall system exceeds the third threshold, the base station adjusts downward the fifth threshold as compared to the initially set one to thereby increase a ratio of Near mobile stations using higher MCS levels. Here, a rise of the effective RoT value means a large amount of interference signals from the neighbor cell. Thus, if the base station increase the ratio of Near mobile stations using higher MCS levels, the amount of interference signals acting on the neighbor cell increase. However, the neighbor cell's base station adjusts downward the maximum allowable MCS level of the Edge mobile station according to the interference control of the first embodiment, so there can be prevented a situation where the base station and the neighbor cell's base station competitively increase the transmission powers of their mobile stations.

In contrast with this, if the effective RoT value becomes lower than the fourth threshold, the base station adjusts upward the fifth threshold as compared to the initially set one to thereby decrease the ratio of Near mobile stations using higher MCS levels. Here, a fall of the effective RoT value means a small amount of interference signals from the neighbor cell. Thus, if the base station decreases the ratio of Near mobile stations using higher MCS levels, the amount of interference signals acting on the neighbor cell decreases. Then, the base station of the neighbor cell adjusts upward the maximum allowable MCS level of the Edge mobile station according to the interference control of the first embodiment, thereby improving the poor channel conditions of the Edge mobile station. In this scenario, the width of upward or downward adjustment of the fifth threshold may be predetermined at the system implementation.

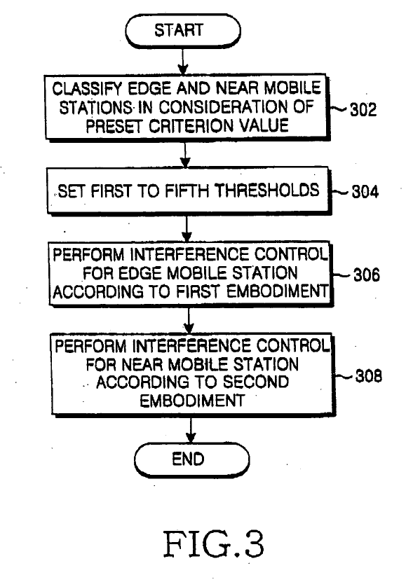

FIG. 3 is a flowchart illustrating interference procedures performed by a base station according to the first and second embodiments. It should be noted that any one or both of the above-mentioned first and second embodiments of the present invention may be applied to a wireless mobile communication system. Referring to FIG. 3, in step 302, a base station presets a criterion value for the discrimination between an Edge mobile station and a Near mobile station, classifies mobile stations into the Edge mobile station and the Near mobile station in consideration of the preset criterion value, and then proceeds to step 304. In step 304, the base station sets the first to fifth thresholds and then proceeds to step 306. Here, the first and second thresholds are set for controlling interference from the Edge mobile station, and the third to fifth thresholds are set for controlling interference from the Near mobile station.

In step 306, the base station performs the control of interference from the Edge mobile station according to the first embodiment and then proceeds to step 308. In step 308, the base station performs the control of the interference from the Near mobile station according to the second embodiment. Here, as previously stated, any one or both of steps 306 and 308 may be performed. If the first and second embodiments are performed together, steps 306 and 308 may be obviously reversed in order.

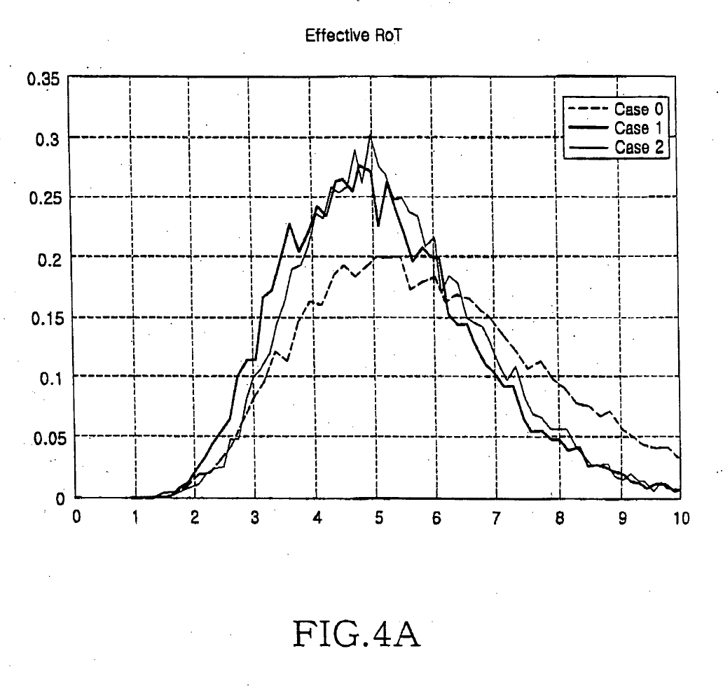

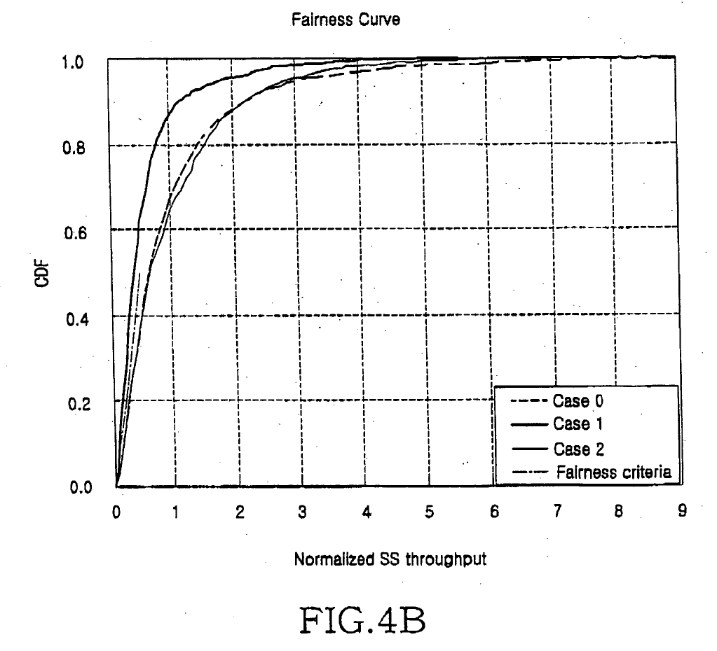

FIGS. 4A and 4B graphically illustrate results of a simulation for comparing effects of the present invention and the conventional art. , It is noted that Case 0 indicates a case where the general interference control method is applied, Case 1 indicates a case where the interference control method according to the first embodiment is applied, and Case 2 indicates a case where the interference control method according to the second embodiment is applied.

Foremost, FIG. 4A illustrates the Probability Density Functions (PDF) of effective RoT values for Cases 0, 1 and 2.

FIG. 4B illustrates the fairness curves of Cases 0, 1 and 2.

Table 1 as set forth below shows throughputs of Cases 0, 1 and 2.

TABLE 1

| | Interference control method | Average |
|---|---|---|
| Throughput | Case 0 | 791001.4 |
| | Case 1 | 937841.0 |
| | Case 2 | 1016156.7 |

As shown in Table 1 above, it can be noted that Cases 0, 1 and 2 have the throughputs ascending in that order.

Further, comparing RoT distributions with reference to FIG. 4A, it can be noted that Case 1 and 2 have relatively smaller RoT variances than that of Case 0, that is, the general interference control method.

In FIG. 4 illustrating the fairness curves, each of which corresponds to a Cumulative Distribution Functions (CDF) of respective mobile stations' processing performances divided by average processing performance, the more the curve is biased to the right with respect to a fairness criterion, the higher fairness is provided. That is, Case 2 ensures higher fairness than that of Case 1 in the interference control.

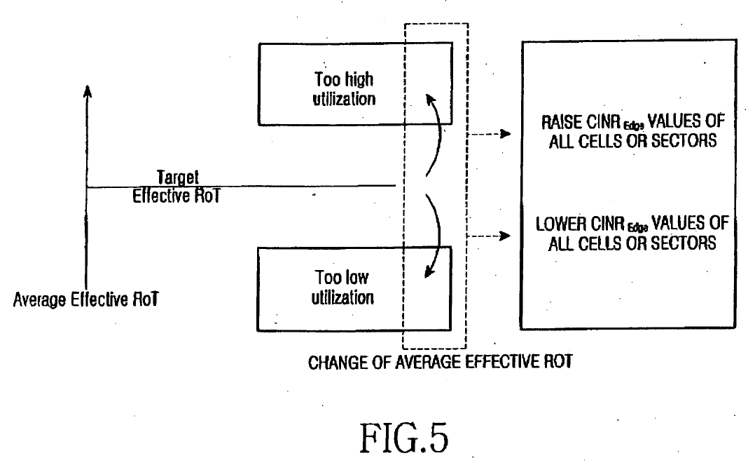

FIG. 5 is a diagrammatic view illustrating an interference control method according to a third embodiment of the present invention. It should be understood that, in order to succeed in the interference control operations according to the first and second embodiments of the present invention, it is important to set an initial value of the fifth threshold, CINR_{Near}, and the upper and lower widths over which the CINR_{Near} value varies to appropriate values according to system conditions. If a frequency reuse pattern or the number of antennas is changed in the system, there may occur a situation where an effective RoT value is extremely raised or lowered. In such a situation, the preset initial value of CINR_{Near} and the upper and lower widths cannot be applied to the system. For example, if the number antennas increase, the effective RoT value is lowered. When the effective RoT value becomes lower than the Effective RoT Low Near Threshold in this way, the CINR_{Near} value increases and finally rises up to the maximum value through repetitive operations. Then, higher MCS levels cannot be allocated to Near mobile stations.

Therefore, in the third embodiment of the present invention, interference control is performed using a newly set CINR_{Edge} and an average effective RoT value in place of an effective RoT value, or the CINR_{Edge} and a transition probability are applied to interference control.

Referring to FIG. 5, a base station receives effective RoT values from cells or sectors and averages them to thereby determine an average effective RoT value. If the determined average effective RoT value exceeds a target effective RoT value, the base station adjusts upward CINR_{Edge} values set in all the cells or sectors by a predetermined value. Alternatively, if the determined average effective RoT value is equal to or less than the target effective RoT, the base station adjusts downward the CINR_{Edge} values set in all the cells or sectors by a predetermined value. The downward adjustment of the CINR_{Edge} values makes it possible to reduce the number of mobile stations to be determined as an Edge mobile station. That is, the CINR_{Edge} value is used for picking out Edge mobile stations. For example, if a specific mobile station has an average effective RoT value lower than the CINR_{Edge} value, it is classified as an Edge mobile station and thus a limitation is put on allocating the maximum allowable MCS level thereto. Thus, if the CINR_{Edge} value is lowered, the number of Edge mobile stations is reduced, so that the number of Edge mobile stations to which the maximum allowable MCS level is allocated increases.

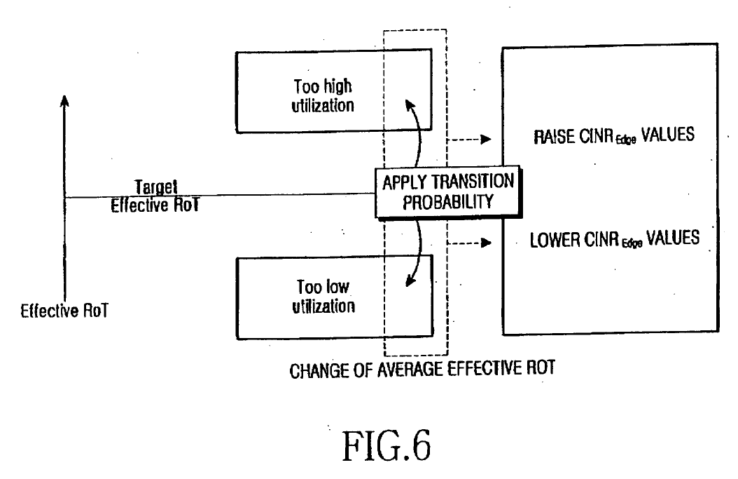

FIG. 6 is a diagrammatic view illustrating another interference control method according to the third embodiment of the present invention. Referring to FIG. 6, the base station performs interference control by using an effective RoT value in place of an average effective RoT value in FIG. 5, and applying a transition probability in changing a CINR_{Edge} value. Here, the transition probability refers to a probability in which the CINR_{Edge} value of a corresponding cell or sector can be changed. That is, since the interference control according to the first embodiment can be affected by a change of the CINR_{Edge} value, the transition probability is generated, and an Edge CINR is changed on a cell-by-cell or sector-by-sector basis only when the CINR_{Edge} value is smaller than a defined threshold.

As previously stated, if the ways of controlling interference as provided herein are applied in combination to a communication system, it is possible to adjust interference according to the channel conditions of mobile stations. By this, the magnitude of interference cannot competitively increase, and an effective RoT value can be maintained at a certain level.

According to the present invention as described above, a base station classifies mobile stations into Edge mobile stations and Near mobile stations while performing interference control in a wireless mobile communication system, thereby preventing the mobile stations from competitively increasing their transmission powers. Particularly, by newly providing an efficient uplink interference control method in the IEEE 802.16 communication system and the portable Internet communication system, the present invention maintains RoT at a certain level in such communication systems.

While the invention has been shown and described with reference to a certain preferred embodiment thereof, it will be understood by those skilled in the art that various changes in form and details may be made therein without departing from the spirit and scope of the invention as defined by the appended claims and equivalents thereof.

What is claimed is:

1. A method for controlling interference signals by a base station in a wireless mobile communication system, the method comprising the steps of:
classifying a plurality of mobile stations into a first mobile station group including mobile stations having good channel conditions with respect to the base station and a second mobile station group including mobile stations having poor channel conditions with respect to the base station; and
setting a first threshold and a second threshold for controlling interferences of the mobile stations belonging to the first mobile station group, adjusting downward a maximum allowable Modulation and Coding Scheme (MCS) level for the mobile stations having Rise over Thermal (RoT) values higher than the first thresholds, and adjusting downward the maximum allowable MCS level for the mobile stations having RoT values lower than the second threshold.

2. The method as claimed in claim 1, further comprising setting a third threshold, a fourth threshold and a fifth threshold for controlling interferences of the mobile stations belonging to the second mobile station group, adjusting downward the fifth threshold to increase a ratio of the mobile stations capable of using the maximum allowable MCS level if there are mobile stations having RoT values higher than the third threshold, and adjusting upward the fifth threshold to decrease the ratio of the mobile stations capable of using the maximum allowable MCS level if there are mobile stations having RoT values lower than the fourth threshold.

3. The method as claimed in claim 1, wherein the base station presets a criterion value for classifying the plurality of mobile stations, and classifies the mobile stations which report channel condition values higher than the criterion value as the first mobile station group, and classifies the mobile stations which report channel condition values lower than the criterion value as the second mobile station group.

4. The method as claimed in claim 2, wherein the fifth threshold is a criterion for allocating the MCS levels of the mobile stations.

5. The method as claimed in claim 1, wherein the first threshold is higher than the second threshold.

6. The method as claimed in claim 2, wherein the third threshold is higher than the fourth threshold.

7. A method for controlling interference signals by a base station in a wireless mobile communication system, the method comprising the steps of:
classifying a plurality of mobile stations into a first mobile station group including mobile stations having good channel conditions with respect to the base station and a second mobile station group including mobile stations having poor channel conditions with respect to the base station; and
adjusting upward a second threshold, which is set for applying MCS levels of the mobile stations belonging to the second mobile station group, by a predetermined value if an average RoT value exceeds a predetermined first threshold, and adjusting downward the second threshold by a predetermined value if the average RoT value is less than or equal tithe first threshold.

8. The method as claimed in claim 7, wherein the first threshold includes an RoT value to be achieved by the base station.

9. The method as claimed in claim 7, wherein the second threshold includes a Carrier-to-Interference-plus-Noise-Ratio (CINR) value.
